(19) United States
(12) Patent Application Publication
(10) Pub. No.: US 2018/0180839 A1
(43) Pub. Date: Jun. 28, 2018

(54) HELIOSTAT AND DRIVING DEVICE FOR DRIVING PANEL OF HELIOSTAT

(71) Applicant: NABTESCO CORPORATION, Tokyo (JP)

(72) Inventors: Motohiro TANAKA, Mie-ken (JP); Shinji INOUE, Mie-ken (JP)

(21) Appl. No.: 15/849,894

(22) Filed: Dec. 21, 2017

(30) Foreign Application Priority Data
Dec. 28, 2016 (JP) 2016-256777
Jan. 25, 2017 (JP) 2017-011589

(51) Int. Cl. G02B 7/183; G02B 19/00; H02S 20/32

(52) U.S. Cl. CPC G02B 7/183; G02B 19/0019; F24J 2002/5437; H02S 20/32; F24J 2/5417; G02B 19/0042

(57) ABSTRACT

One object is to reduce an allowable torque of a driving device. A driving device for driving a panel of a heliostat includes a second axis driving portion for rotating the panel around a second axis non-parallel to a first axis around which the panel is turned with respect to a horizontal plane. The second axis of the second axis driving portion is inclined at a predetermined angle with respect to a panel surface of the panel.

### CROSS-REFERENCE TO RELATED APPLICATIONS

This application is based on and claims the benefit of priority from Japanese Patent Application Serial No. 2016-256777 (filed on Dec. 28, 2016) and Japanese Patent Application Serial No. 2017-011589 (filed on Jan. 25, 2017), the contents of which are hereby incorporated by reference in their entirety.

### TECHNICAL FIELD

The present invention relates to a heliostat provided with a panel and a driving device for driving the panel. The present invention also relates to a driving device for driving a panel of a heliostat.

### BACKGROUND

There is known a system utilizing sunlight, such as a solar thermal power generation system or a solar photovoltaic power generation system. For example, Japanese Patent Application Publication No. 2015-105791 (“the '791 Publication”) discloses a solar thermal power generation system provided with a plurality of heliostats and a power generation device. Each of the plurality of heliostats reflects sunlight toward a portion for transmitting heat to a heat medium, such as a receiver of the power generation device. The power generation device heats the heat medium using the sunlight reflected by the plurality of heliostats to generate steam and utilizes power of the steam to generate power.

A heliostat is provided with, for example, a panel including a reflection member for reflecting sunlight, such as a mirror, and a driving device for driving the panel. The driving device controls an attitude of the panel so that sunlight reflected by the panel travels toward a receiver. For example, in the '791 Publication, a driving device has a turning unit for turning a panel in a horizontal direction and a raising/lowering unit for raising and lowering the panel in an up-down direction.

In the solar thermal power generation system described in the '791 Publication, the raising/lowering unit controls a tilt angle of the panel with respect to a horizontal plane by rotating the panel around a raising/lowering shaft member extending in the horizontal direction along the panel. When the panel in a state of being orthogonal to the horizontal plane is shifted to a state of being parallel to the horizontal plane, the raising/lowering unit temporarily drives the panel in a direction diametrically opposite to gravity acting on the panel. Because of this, an allowable torque (maximum torque) of the raising/lowering unit becomes large, resulting in a size increase of constituent elements of the raising/lowering unit such as a speed reducer and a motor.

### SUMMARY

The present invention has as its object to provide a heliostat and a driving device capable of effectively solving such a problem.

The present invention provides a driving device for driving a panel of a heliostat, which includes a second axis driving portion for rotating the panel around a second axis non-parallel to a first axis around which the panel is turned with respect to a horizontal plane. In the driving device, the second axis of the second axis driving portion is inclined at a predetermined angle with respect to a panel surface of the panel.

In the driving device according to the present invention, preferably, the panel can be moved to reach a horizontal position at which the panel surface is substantially parallel to the horizontal plane.

In the driving device according to the present invention, preferably, the panel can be moved to reach a vertical position at which the panel surface is substantially orthogonal to the horizontal plane.

In the driving device according to the present invention, preferably, the second axis driving portion rotates the panel in a first direction around the second axis so that the panel can be moved from the horizontal position to reach the vertical position and so that the panel can be moved from the vertical position to reach the horizontal position.

In the driving device according to the present invention, it may also be possible that the second axis of the second axis driving portion is inclined at an angle of 35° to 55° with respect to the panel surface of the panel

In the driving device according to the present invention, it may also be possible that the second axis forms an angle of 125° to 145° with the horizontal plane.

In the driving device according to the present invention, it may also be possible that an extension of the second axis intersects with a center-of-gravity region of the panel

In the driving device according to the present invention, it may also be possible that the second axis driving portion is provided with a second axis motor having an output shaft and a second axis speed reducer joined to the output shaft of the second axis motor. In this case, it may also be possible that the second axis speed reducer of the second axis driving portion has an allowable torque smaller than an allowable torque of a first axis speed reducer of a first axis driving portion for rotating the panel around the first axis. Furthermore, it may also be possible that the second axis speed reducer of the second axis driving portion has a diameter smaller than a diameter of a first axis speed reducer of a first axis driving portion for rotating the panel around the first axis. Furthermore, it may also be possible that the second axis motor is positioned on an opposite side to the panel with respect to an intersection between the first axis and the second axis. Furthermore, it may also be possible that a center of gravity of the second axis speed reducer is positioned on an opposite side to the panel with respect to an intersection between the first axis and the second axis. Furthermore, it may also be possible that a mounting surface of the second axis speed reducer on an output side thereof is positioned on an opposite side to the panel with respect to an intersection between the first axis and the second axis.

In the driving device according to the present invention, it may also be possible to further include a support portion joined on one end to the second axis driving portion and on the other end to the panel. In this case, it may also be possible that the support portion has a first support member joined to the second axis driving portion and parallel to the second axis and a second support member joined to the first support member and inclined with respect to the second axis.

In the driving device according to the present invention, it may also be possible that the panel includes a reflection member for reflecting sunlight.

In the driving device according to the present invention, it may also be possible that the panel includes a solar battery.

The present invention provides a heliostat including a panel, a first axis driving portion for rotating the panel around a first axis so that the panel is turned with respect to a horizontal plane, and a second axis driving portion for rotating the panel around a second axis non-parallel to the first axis, the second axis driving portion being joined to the first axis driving portion. In the heliostat, the second axis of the second axis driving portion is inclined at a predetermined angle with respect to a panel surface of the panel.

### Advantages

According to the present invention, there can be reduced an allowable torque (maximum torque) of a second axis driving portion capable of controlling a tilt angle of a panel with respect to a horizontal plane.

### BRIEF DESCRIPTION OF THE DRAWINGS

FIG. 1 is a perspective view showing a heliostat according to one embodiment.

FIG. 2 is a side view showing the heliostat in a state where a panel surface is at a vertical position.

FIG. 3 is a side view showing the heliostat in a state of having been rotated 90° about a second axis from the state shown in FIG. 2.

FIG. 4 is a side view showing the heliostat in a state where the panel surface is at a horizontal position.

FIG. 5 is a view in which a second axis driving portion and a panel of the heliostat in the state shown in FIG. 2 are projected on an orthogonal plane.

FIG. 6 is a view in which the second axis driving portion and the panel of the heliostat in the state shown in FIG. 3 are projected on the orthogonal plane.

FIG. 7 is a view in which the second axis driving portion and the panel of the heliostat in the state shown in FIG. 4 are projected on the orthogonal plane.

FIG. 8 is a side view showing a heliostat according to a comparative embodiment.

FIG. 9 is a side view showing a heliostat according to a first modification example.

FIG. 10 is a side view showing a heliostat according to a second modification example.

FIG. 11 is a side view showing a heliostat according to a third modification example.

FIG. 12 is a side view showing a heliostat according to a fourth modification example.

### DESCRIPTION OF THE PREFERRED EMBODIMENTS

With reference to the appended drawings, the following describes in detail a heliostat and a driving device according to an embodiment of the present invention. Embodiments described below are each one example of an embodiment of the present invention, and the present invention is not intended to be construed as being limited thereto. Furthermore, in the drawings referred to in the embodiment, the same parts or parts having similar functions are denoted by the same or like reference characters, and duplicate descriptions thereof are possibly omitted. Furthermore, for the sake of convenience of description, a dimensional ratio of the drawings is possibly different from an actual dimensional ratio, and some elements of a configuration are possibly omitted from the drawings.

Heliostat

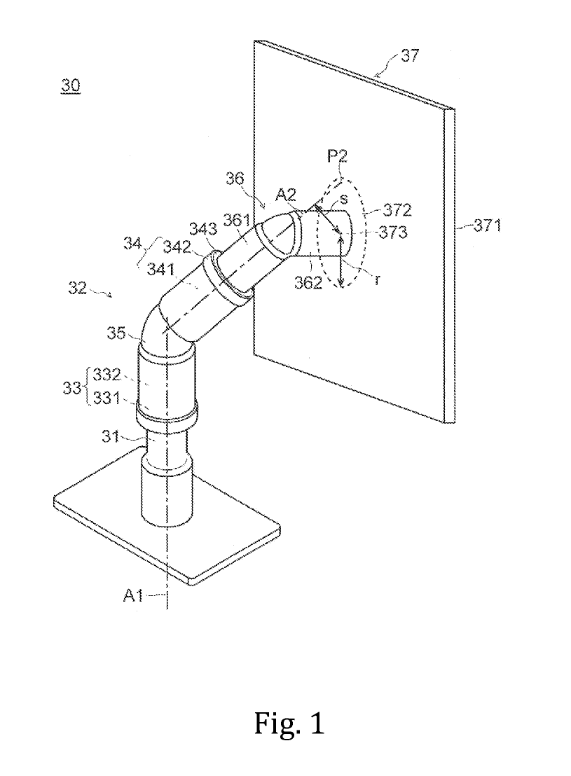

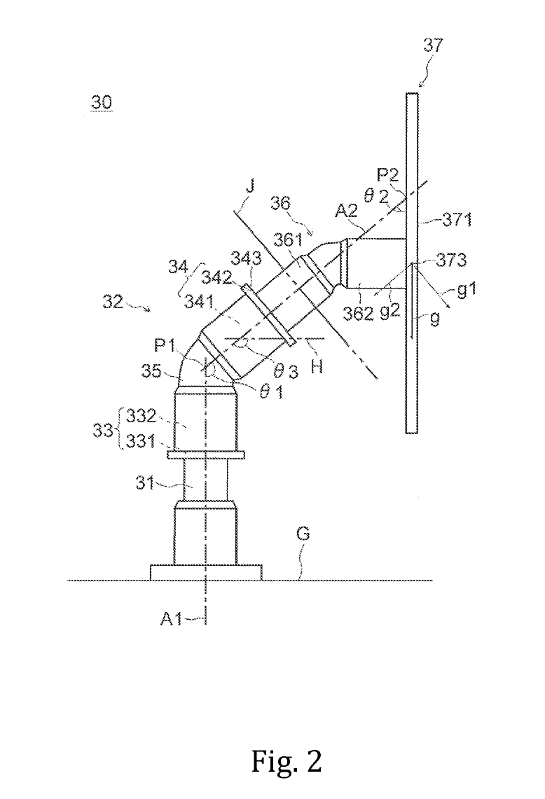

FIG. 1 is a perspective view showing a heliostat 30 according to the embodiment. Furthermore, FIG. 2 is a side view showing the heliostatn 30. In the embodiment, the heliostat 30 is configured to reflect sunlight toward an object such as a power generation device.

The heliostat 30 is provided with a support column 31, a driving device 32, a panel 37. The support 31 is a member fixed to a ground G and extending in a vertical direction. The driving device 32 is joined to an upper end of the support column 31. The support column 31 may include a hollow member having a cavity inside. In this case, in the cavity inside the support column 31, wiring may be disposed to be connected to the driving device 32. With this configuration, the wiring can be inhibited from being affected by an external environment, and thus reliability thereof can be improved.

The driving device 32 drives the panel 37. The driving device 32 is provided with a first axis driving portion 33, a second axis driving portion 34, a fixing portion 35, and a support portion 36. The panel 37 includes a reflection member 371 for reflecting sunlight. The reflection member 371 is, for example, a mirror. The driving device 32 is required to control an attitude of the panel 37 with high accuracy so that reflected sunlight travels toward an object.

The following describes constituent elements of the driving device 32.

The first axis driving portion 33 rotates the panel 37 around a first axis A1. The first axis A1 is, for example, an axis orthogonal to a horizontal direction. In this case, the panel 37 is rotated around the first axis A1 so that the panel 37 can be turned with respect to a horizontal plane. In the embodiment, the first axis A1 is parallel to the support column 31.

The first axis driving portion 33 has, for example, a first axis motor 331 and a first axis speed reducer 332 joined to an output shaft of the first axis motor 331. The first axis speed reducer 332 can have any structure. For example, as the first axis speed reducer 332, a planetary gear speed reducer, an eccentric oscillation speed reducer, or a worm speed reducer can be used.

The second axis driving portion 34 rotates the panel 37 around a second axis A2 non-parallel to the first axis A1 of the first axis driving portion 33. The term “non-parallel” refers to an angle θ1 (see FIG. 2) formed between the first axis A1 and the second axis A2 being other than 0° and180°.

As shown in FIG. 1 and FIG. 2, the second axis A2 of the second axis driving portion 34 is inclined at a predetermined inclination angle θ2 with respect to a panel surface of the panel 37. The term “inclined” refers to the inclination angle θ2 being other than 0°, 90°, and 180°. When the panel 37 is rotated one turn about the second axis A2, a center of gravity 373 of the panel 37 draws a trajectory in the shape of a circle having a radius s about the second axis A2 in a plane orthogonal to the second axis A2 and passing through the center of gravity 373. The radius s represents a distance between the second axis A2 and the center of gravity 373 in the plane orthogonal to the second axis A2 and passing through the center of gravity 373.

The second axis driving portion 34 is provided with, for example, a second axis motor 341 having an output shaft and a second axis speed reducer 342 joined to the output shaft of the second axis motor 341. Similarly to the first axis speed reducer 332, the second axis speed reducer 342 can have any structure. For example, as the second axis speed reducer 342, a planetary gear speed reducer, an eccentric oscillation speed reducer, or a worm speed reducer can be used.

The fixing portion 35 is a member for fixing the second axis driving portion 34 to the first axis driving portion 33. There is no particular limitation on a specific configuration of the fixing portion 35 as long as the angle θ1 formed between the first axis A1 and the second axis A2 can be maintained at a predetermined value.

The support portion 36 is a member joined on one end to the second axis driving portion 34 and on the other end to the panel 37. For example, the support portion 36 has a first support member 361 joined to the second axis driving portion 34 and parallel to the second axis A2 and a second support member 362 joined to the first support member 361 and inclined with respect to the second axis A2. In the embodiment, the second support member 362 extends in the horizontal direction.

In an example shown in FIG. 1 and FIG. 2, an end portion of the second support member 362 is joined to the panel 37. Though not shown, it may also be possible, however, that any other constituent element of the support portion 36 such as a torque tube is interposed between the end portion of the second support member 362 and the panel 37. For example, the torque tube is mounted to the panel 37 so as to extend parallel to the panel 37.

Next, a description is given of a positional relationship between the constituent elements of the driving device 32.

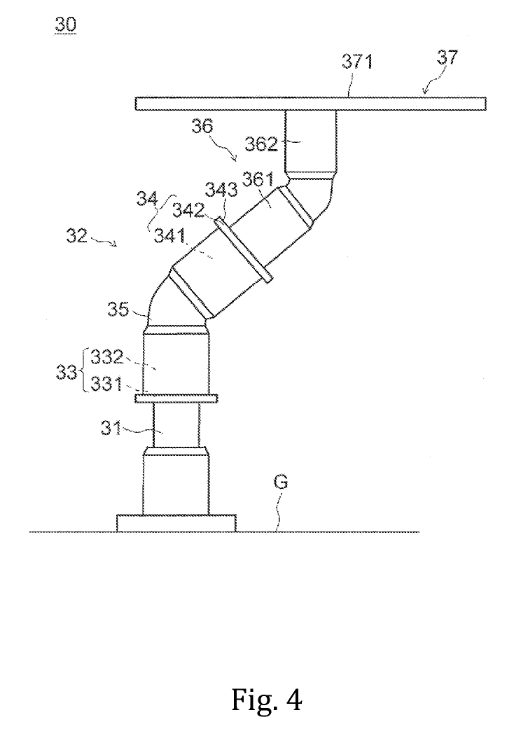

Preferably, the constituent elements of the driving device 32 are configured so that, as shown in FIG. 1 and FIG. 2, the panel 37 can be moved to reach a vertical position at which the panel surface is substantially orthogonal to the horizontal plane. Furthermore, preferably, the constituent elements of the driving device 32 are configured so that, as shown in FIG. 4, the panel 37 can be moved to reach a horizontal position at which the panel surface is substantially parallel to the horizontal plane. The term “substantially orthogonal” refers to an angle formed between a horizontal plane H (see FIG. 2) such as the ground G and the panel surface of the panel 37 being 80° to 100°. Furthermore, the term “substantially parallel” refers to the angle formed between the horizontal plane H and the panel surface of the panel 37 being −10° to 10°.

The vertical position is, for example, a position assumed by the panel 37 when the sun is at a low elevation. Furthermore, the panel 37 may be positioned at the vertical position for a cleaning purpose. The horizontal position is, for example, a position assumed by the panel 37 when the sun is at a high elevation. Furthermore, the panel 37 may be positioned at the horizontal position so that a load applied to the panel 37 due to a strong wind or the like is reduced.

One example of a method for achieving the above-mentioned vertical position and horizontal position is to appropriately set the inclination angle θ2 formed by the second axis A2 with the panel surface of the panel 37 and an angle θ3 (see FIG. 2) formed by the second axis A2 with the horizontal plane H. For example, the inclination angle θ2 is set to 35° to 55°, and the angle θ3 is set to 125° to 145°. With this configuration, the second axis driving portion 34 rotates the panel 37 around the second axis A2, thus making it possible to achieve the vertical position and the horizontal position of the panel 37. In this case, the second axis driving portion 34 can control the panel 37 to be at any tilt angle with respect to the horizontal plane H between the vertical position and the horizontal position.

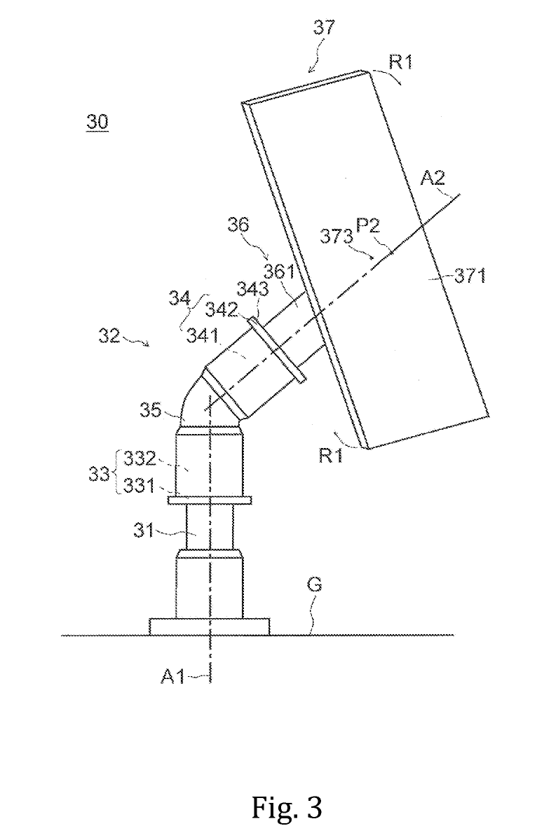

FIG. 3 is a side view showing a state where the panel 37 is positioned at an intermediate position between the vertical position shown in FIG. 2 and the horizontal position shown in FIG. 4. For example, the panel 37 in the state shown in FIG. 2 is rotated 90° in a first direction R1 about the second axis A2, thus being brought to the state shown in FIG. 3. Furthermore, the panel 37 in the state shown in FIG. 3 is rotated 90° in the first direction R1 about the second axis A2, thus being brought to the state shown in FIG. 4.

Method for Controlling Heliostat

Next, with reference to FIG. 2 to FIG. 7, a description is given of one example of a method for controlling the heliostat 30. Herein, the description is directed to an example in which the panel 37 is driven from the vertical position shown in FIG. 2 to the horizontal position shown in FIG. 4 via the intermediate position shown in FIG. 3.

In FIG. 2, reference character J denotes a plane orthogonal to the second axis A2 (hereinafter, referred to also as an orthogonal plane). Furthermore, reference character g denotes gravity acting on the panel 37. Furthermore, reference character g1 denotes a component of the gravity g parallel to the orthogonal plane J, and reference character g2 denotes a component of the gravity g orthogonal to the orthogonal plane J, namely, a component of the gravity g parallel to the second axis A2. In the embodiment, the second axis A2 of the second axis driving portion 34 is inclined with respect to the first axis A1 of the first axis driving portion 33. For example, the angle θ1 formed between the first axis A1 and the second axis A2 is 125° to 145°. With this configuration, the component g1 of the gravity g parallel to the orthogonal plane J can be made smaller than the gravity g.

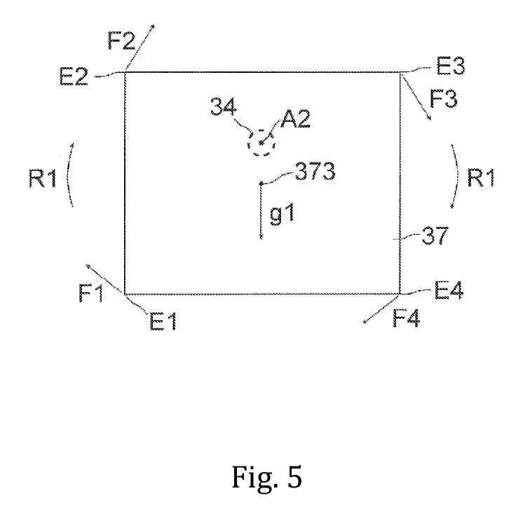

FIG. 5 is a view in which the second axis driving portion 34 and the panel 37 of the heliostat 30 in the state shown in FIG. 2 are projected on the orthogonal plane J. In FIG. 5, reference characters E1 to E4 denote corner portions of the panel 37 in a rectangular shape, respectively. Furthermore, reference characters F1 to F4 denote forces required at the corner portions E1 to E4 for rotating the panel 37 in the first direction R1 about the second axis A2, respectively. As shown in FIG. 5, the forces F1 and F2 have a component directed against the component g1 of the gravity g, and the forces F3 and F4 have a component in the same direction as the component g1 of the gravity g. For this reason, compared with a case where all the forces F1 to F4 are directed against the component g1 of the gravity g, a force required for rotating the panel 37 in the first direction R1 is reduced. Thus, in the state shown in FIG. 2, the second axis driving portion 34 can rotate the panel 37 in the first direction R1 with a reduced torque.

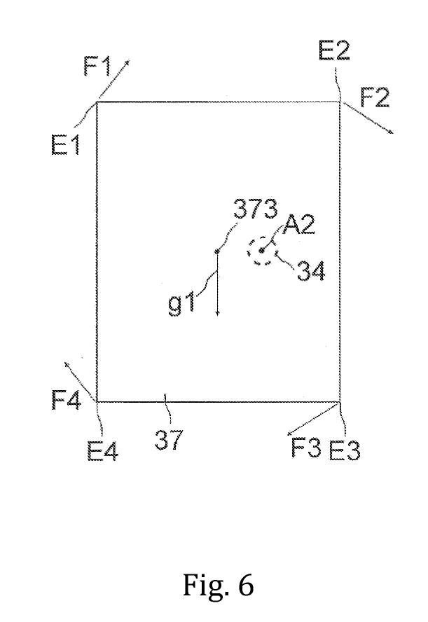

FIG. 6 is a view showing a state where the panel 37 in a state shown in FIG. 5 is rotated 90° in the first direction R1 about the second axis A2. FIG. 6 is also a view in which the panel 37 positioned at the intermediate position shown in FIG. 3 is projected on the orthogonal plane J. Similarly to a case of the state shown in FIG. 5, also in the state shown in FIG. 6, forces F1 to F4 include both of a component directed against the component g1 of the gravity g and a component in the same direction as the component g1 of the gravity g.

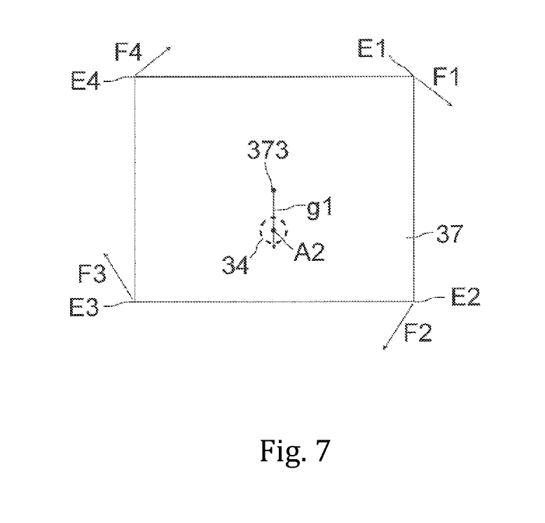

FIG. 7 is a view showing a state where the panel 37 in the state shown in FIG. 6 is rotated 90° in the first direction R1 about the second axis A2. FIG. 7 is also a view in which the panel 37 positioned at the horizontal position shown in FIG. 4 is projected on the orthogonal plane J. Similarly to a case of the state shown in FIG. 5, also in the state shown in FIG. 7, forces F1 to F4 include both of a component directed against the component g1 of the gravity g and a component in the same direction as the component g1 of the gravity g.

Effects of Heliostat According to the Embodiment

According to the embodiment, the second axis A2 of the second axis driving portion 34 for controlling a tilt angle of the panel 37 with respect to the horizontal plane H is inclined at the predetermined inclination angle θ2 with respect to the panel 37. Consequently, a torque required to rotate the panel 37 about the second axis A2 comes to include both of a component directed against gravity and a component in the same direction as the gravity. For this reason, compared with a case where, as in the '791 Publication mentioned above, a panel is rotated around a shaft extending in a horizontal direction along the panel, an allowable torque (maximum torque) of the second axis driving portion 34 required to rotate the panel 37 can be reduced. For example, an allowable torque of the second axis speed reducer 342 of the second axis driving portion 34 can be made smaller than an allowable torque of the first axis speed reducer 332 of the first axis driving portion 33. This enables a size reduction of the constituent elements of the second axis driving portion 34 such as the second axis speed reducer 342 and the second axis motor 341. For example, a diameter of the second axis speed reducer 342 of the second axis driving portion 34 can be made smaller than a diameter of the first axis speed reducer 332 of the first axis driving portion 33.

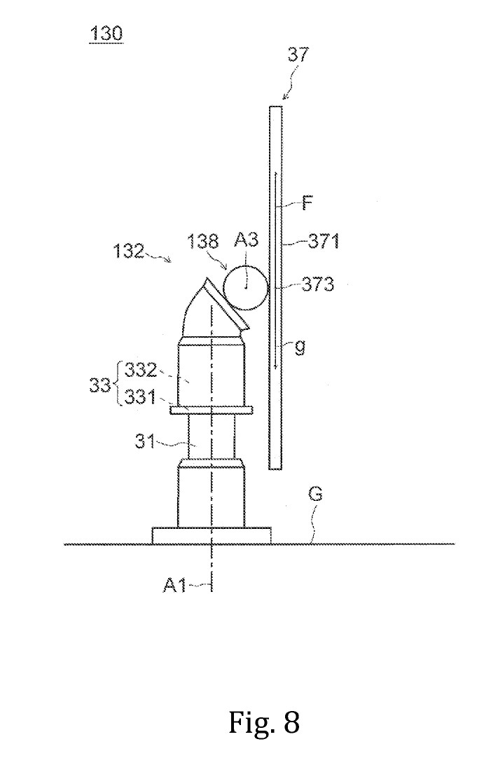

The following describes an effect of the heliostat 30 according to the embodiment based on a comparison with a heliostat 130 according to a comparative embodiment. As in the '791 Publication mentioned above, the heliostat 130 shown in FIG. 8 is provided with a driving portion 138 for rotating a panel 37 around a shaft A3 extending in a horizontal direction along the panel 37. In this case, a direction of a force F required for rotating the panel 37 positioned at a vertical position shown in FIG. 8 is against gravity g acting on the panel 37. Because of this, in the comparative embodiment, a torque required for rotating the panel 37 being at the vertical position is large, resulting in an increase in allowable torque (maximum torque) of the driving portion 138.

In contrast, according to the embodiment, at least part of a torque required to rotate the panel 37 being at the vertical position about the second axis A2 is in the same direction as a component of the gravity g, and thus an allowable torque (maximum torque) of the second axis driving portion 34 can be reduced.

Furthermore, preferably, as shown in FIG. 1, the second axis driving portion 34 and the panel 37 are disposed so that an intersection P2 between an extension of the second axis A2 and the panel 37 is positioned within a center-of-gravity region 372. With this configuration, an allowable torque (maximum torque) of the second axis driving portion 34 required to rotate the panel 37 can be further reduced. The “center-of-gravity region” is a region on an inner side of a circle having a radius r about the center of gravity 373 of the panel 37. The radius r is set so that an area of the circle having the radius r is one-tenth of an area of the panel surface of the panel 37.

Furthermore, preferably, the second axis driving portion 34 is configured to rotate the panel 37 in the first direction R1 around the second axis A2 so that the panel 37 can be moved from the horizontal position to reach the vertical position and so that the panel 37 can be moved from the vertical position to reach the horizontal position. In other words, the second axis driving portion 34 is configured so that the panel 37 can be rotated 360° around the second axis A2.

Various modifications can be made to the foregoing embodiment.

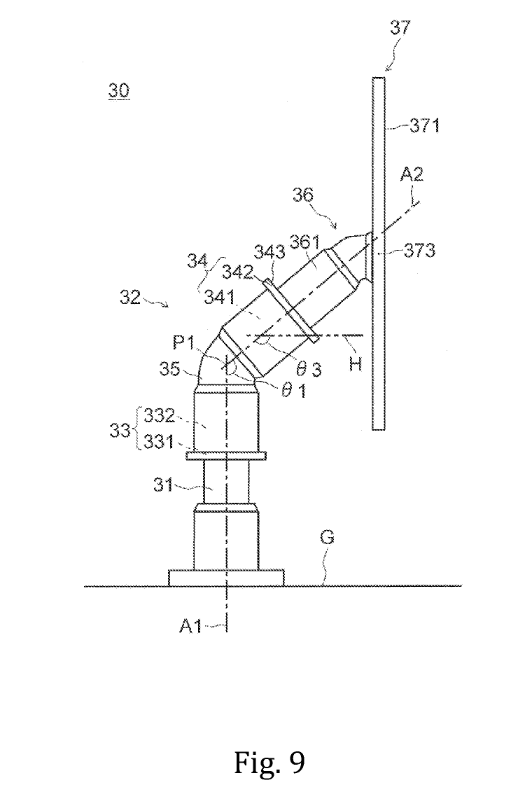

The foregoing embodiment has described an example in which the support portion 36 positioned between the second axis driving portion 34 and the panel 37 has, in addition to the first support member 361 extending parallel to the second axis A2, the second support member 362 inclined with respect to the second axis A2. It may also be possible, however, that, as shown in FIG. 9, the second support member 362 is not provided between the first support member 361 and the panel 37. For example, the first support member 361 may be joined to the panel 37. With this configuration, it becomes easier to approximate the intersection P2 between an extension of the second axis A2 and the panel 37 to the center of gravity 373 of the panel 37. Furthermore, a distance from the panel 37 to the first axis A1 can be reduced

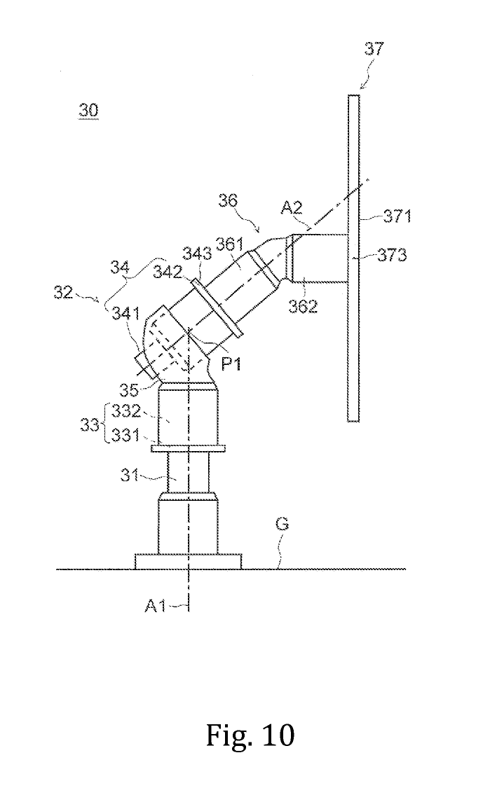

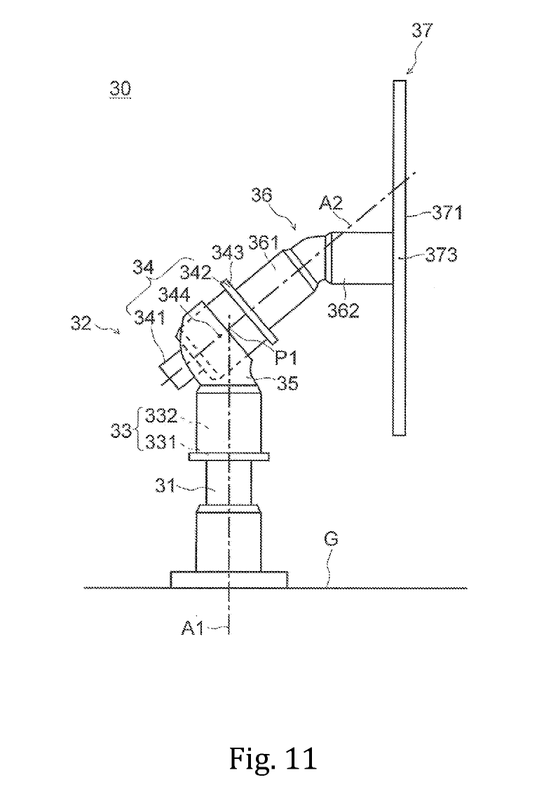

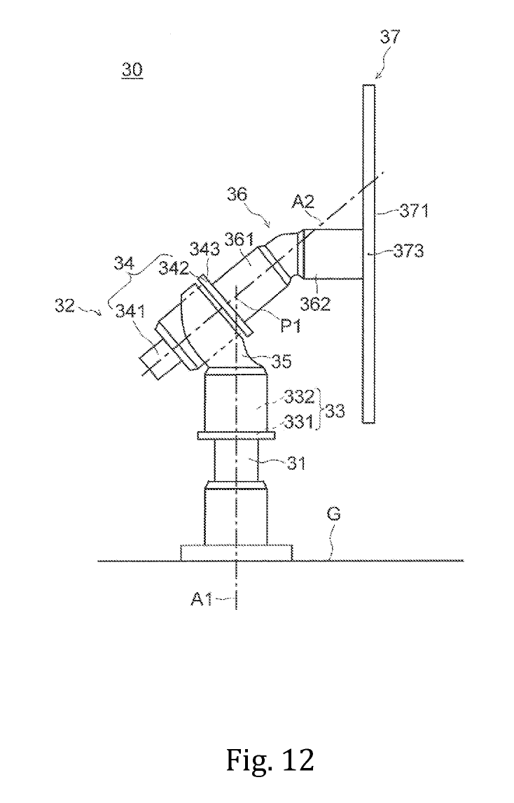

Furthermore, the foregoing embodiment has described an example in which the second axis driving portion 34 is positioned on the same side as the panel 37 with respect to an intersection P1 between the first axis A1 and the second axis A2. Though not shown, it may also be possible, however, that the second axis driving portion 34 is at least partly positioned on an opposite side to the panel 37 with respect to the intersection P1 between the first axis A1 and the second axis A2. For example, it may also be possible that, as shown in FIG. 10, the second axis motor 341 is positioned on the opposite side to the panel 37 with respect to the intersection P1 between the first axis A1 and the second axis A2. Furthermore, it may also be possible that, as shown in FIG. 11, a center of gravity 344 of the second axis speed reducer 342 is positioned on the opposite side to the panel 37 with respect to the intersection P1 between the first axis A1 and the second axis A2. Furthermore, it may also be possible that, as shown in FIG. 12, a mounting surface 343 of the second axis speed reducer 342 on an output side thereof is positioned on the opposite side to the panel 37 with respect to the intersection P1 between the first axis A1 and the second axis A2.

Furthermore, the foregoing embodiment has described an example in which the reflection member 371 of the panel 37 reflects sunlight toward the power generation device. That is, the example has explained that a sunlight utilization system provided with a plurality of heliostats 30 is a solar thermal power generation system. The use of such a sunlight utilization system provided with a plurality of heliostats 30, however, is not limited to a solar thermal power generation system. For example, it may also be possible that the sunlight utilization system is a system that utilizes heat of sunlight reflected by the plurality of heliostats 30 to purify distilled water. Furthermore, the sunlight utilization system may be a solar photovoltaic power generation system. In this case, a panel 37 of each of the heliostats 30 includes a solar battery for converting sunlight into electric power by a photoelectric effect.

While several modification examples with respect to the foregoing embodiment have been described thus far, needless to say, plural ones of the modification examples can be combined as appropriate, and such combinations are also applicable to the present invention.

What is claimed is:

1. A driving device for driving a panel of a heliostat, comprising:
a second axis driving portion for rotating the panel around a second axis non-parallel to a first axis around which the panel is turned with respect to a horizontal plane,
wherein the second axis of the second axis driving portion is inclined at a predetermined angle with respect to a panel surface of the panel

2. The driving device according to claim 1, wherein the panel can be moved to reach a horizontal position at which the panel surface is substantially parallel to the horizontal plane.

3. The driving device according to claim 1, wherein the panel can be moved to reach a vertical position at which the panel surface is substantially orthogonal to the horizontal plane.

4. The driving device according to claim 2, wherein the panel can be moved to reach a vertical position at which the panel surface is substantially orthogonal to the horizontal plane.

5. The driving device according to claim 4, wherein the second axis driving portion rotates the panel in a first direction around the second axis, so that the panel can be moved from the horizontal position to reach the vertical position and so that the panel can be moved from the vertical position to reach the horizontal position.

6. The driving device according to claim 1, wherein the second axis of the second axis driving portion is inclined at an angle of 35° to 55° with respect to the panel surface of the panel.

7. The driving device according to claim 1, wherein the second axis forms an angle of 125° to 145° with the horizontal plane.

8. The driving device according to claim 1, wherein an intersection between an extension of the second axis and the panel is positioned within a center-of-gravity region of the panel.

9. The driving device according to claim 1, wherein
the second axis driving portion comprises:
a second axis motor having an output shaft and
a second axis speed reducer joined to the output shaft of the second axis motor.

10. The driving device according to claim 9, wherein the second axis speed reducer of the second axis driving portion has an allowable torque smaller than an allowable torque of a first axis speed reducer of a first axis driving portion for rotating the panel around the first axis.

11. The driving device according to claim 9, wherein the second axis speed reducer of the second axis driving portion has a diameter smaller than a diameter of a first axis speed reducer of a first axis driving portion for rotating the panel around the first axis.

12. The driving device according to claim 9, wherein the second axis motor is positioned on an opposite side to the panel with respect to an intersection between the first axis and the second axis.

13. The driving device according to claim 9, wherein a center of gravity of the second axis speed reducer is positioned on an opposite side to the panel with respect to an intersection between the first axis and the second axis.

14. The driving device according to claim 9, wherein a mounting surface of the second axis speed reducer on an output side thereof is positioned on an opposite side to the panel with respect to an intersection between the first axis and the second axis.

15. The driving device according to claim 1, further comprising:
a support portion joined on one end to the second axis driving portion and on another end to the panel

16. The driving device according to claim 15, wherein
the support portion has:
a first support member joined to the second axis driving portion and parallel to the second axis; and
a second support member joined to the first support member and inclined with respect to the second axis.

17. The driving device according to claim 1, wherein the panel includes a reflection member for reflecting sunlight.

18. The driving device according to claim 1, wherein the panel includes a solar battery.

19. A heliostat, comprising:
a panel;
a first axis driving portion for rotating the panel around a first axis so that the panel is turned with respect to a horizontal plane; and
a second axis driving portion for rotating the panel around a second axis non-parallel to the first axis, the second axis driving portion being joined to the first axis driving portion,
wherein the second axis of the second axis driving portion is inclined at a predetermined angle with respect to a panel surface of the panel
